(19) United States
(12) Patent Application Publication
(10) Pub. No.: US 2014/0028744 A1
(43) Pub. Date: Jan. 30, 2014

(54) INFORMATION READING DEVICE

(71) Applicant: PANASONIC CORPORATION, Osaka (JP)

(72) Inventors: Hideyuki HASHI, Osaka (JP); Kazuhiro YAMADA, Osaka (JP); Naoto YUMIKI, Osaka (JP)

(73) Assignee: PANASONIC CORPORATION, Osaka (JP)

(21) Appl. No.: 13/950,114

(22) Filed: Jul. 24, 2013

(30) Foreign Application Priority Data
Jul. 27, 2012 (JP) 2012-166780
Jul. 27, 2012 (JP) 2012-166781
Jul. 27, 2012 (JP) 2012-166782
Jun. 27, 2013 (JP) 2013-134588

(51) Int. Cl. G09G 3/34

(52) U.S. Cl. CPC G09G 3/3406
USPC 345/697; 345/102

(57) ABSTRACT

The present invention includes a light source unit that emits light to an information pattern including a plurality of marks that can optically be read; an image reading unit that reads information from the information pattern; and a case that houses the light source unit and the image reading unit, and has on its leading end an opening through which light from the light source unit is emitted to the information pattern and into which light for reading the information by the image reading unit is incident. The case has on its leading end a projecting portion formed to have a diameter larger than other parts of the case.

### BACKGROUND OF THE INVENTION

1. Field of the Invention

The present invention relates to an information reading device used for an information display apparatus that enables a handwriting input on a display surface of the display apparatus.

2. Description of the Related Art

There has been known a technique of providing a secondary code including coded coordinate information on a print medium such as a sheet, and specifying a position of image information formed on the print medium (see Unexamined Japanese Patent Publication No. 2007-226577).

As a technique of enabling a handwriting input on the display apparatus, there is also a technique of detecting a coordinate on a display apparatus with an input pen according to a resistive touch system or a capacitance system, and displaying information such as a character based upon the detected coordinate information. In this apparatus, a coordinate instruction range on the display apparatus and a display screen of a display unit are associated with each other, and when the input pen is moved on the display screen of the display apparatus, information such as a character is displayed on the display screen according to the movement of the input pen.

### SUMMARY OF THE INVENTION

The present invention includes a light source unit that emits light to an information pattern including a plurality of marks that can optically be read; an image reading unit that reads information from the information pattern; and a case that houses the light source unit and the image reading unit, and has on a leading end an opening through which the light from the light source unit is emitted to the information pattern and into which light for reading the information by the image reading unit enters. The case has a projecting portion formed on the leading end, the projecting portion having a diameter larger than other parts of the case.

The present invention can realize a compact and easy-to-use structure of an information reading device used for an information display apparatus that enables a handwriting input with high precision.

### BRIEF DESCRIPTION OF DRAWINGS

FIG. 1 is a view illustrating a schematic configuration of an information display apparatus according to one exemplary embodiment of the present invention;

FIG. 2 is a schematic view illustrating a configuration of an electronic pen and a display apparatus in the information display apparatus according to one exemplary embodiment of the present invention;

FIG. 3 is an explanatory view illustrating one example of an information pattern disposed on a display surface of the display apparatus;

FIG. 4A is an explanatory view illustrating one example of a method of obtaining a position coordinate from the information pattern;

FIG. 4B is an explanatory view illustrating one example of a method of obtaining a position coordinate from the information pattern;

FIG. 4C is an explanatory view illustrating one example of a method of obtaining a position coordinate from the information pattern;

FIG. 4D is an explanatory view illustrating one example of a method of obtaining a position coordinate from the information pattern;

FIG. 5 is a schematic view illustrating a configuration of a display panel on which the information pattern is disposed in the display apparatus;

FIG. 6 is a perspective view illustrating an appearance of the electronic pen according to one exemplary embodiment of the present invention;

FIG. 7 is a plan view of the appearance of the electronic pen viewed from a lateral direction according to one exemplary embodiment of the present invention;

FIG. 8 is a plan view of the appearance of the electronic pen viewed from an opening of the electronic pen according to one exemplary embodiment of the present invention;

FIG. 9 is a perspective view illustrating an internal structure of the electronic pen with a lower case being removed according to one exemplary embodiment of the present invention;

FIG. 10 is an enlarged perspective view illustrating an A part in FIG. 9;

FIG. 11A is an explanatory view illustrating a state in which a user uses the electronic pen according to one exemplary embodiment of the present invention; and

FIG. 11B is an explanatory view illustrating a state in which a user uses the electronic pen according to one exemplary embodiment of the present invention.

### DETAILED DESCRIPTION OF THE PREFERRED EMBODIMENT

In the description below, a liquid crystal display apparatus is used as one example of an information display apparatus using an information reading device according to one exemplary embodiment of the present invention. However, other display apparatuses such as an EL display apparatus may be used.

Description more than necessary might not be given below. For example, the detailed description of a known matter or the redundant description for substantially the same component might not be given. This is because a person skilled in the art can easily understand the invention by avoiding unnecessary redundant description below.

The inventors provide accompanying drawings and description below for fully understanding of the present invention by a person skilled in the art, and do not intend to limit the scope of the claims of the present invention by the accompanying drawings and description below.

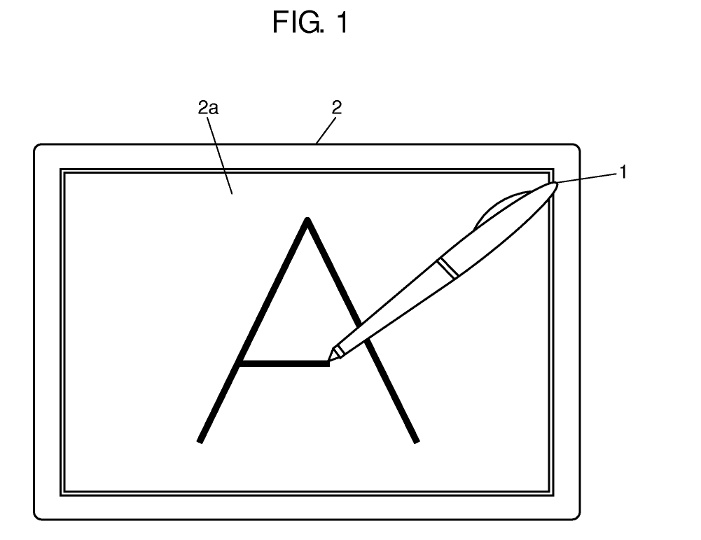

FIG. 1 is a view illustrating a schematic configuration of an information display apparatus using an information reading device according to one exemplary embodiment of the present invention. As illustrated in FIG. 1, the information display apparatus includes optical electronic pen 1 serving as an information reading device that enables a handwriting input, and display apparatus 2 that receives position information indicated by electronic pen 1 and includes a display panel displaying a character or a graphic on display surface 2a. Although not illustrated in FIG. 1, an information pattern having a plurality of dot-like marks that can optically be read by electronic pen 1 is disposed on a display area of the display panel of display apparatus 2.

Specifically, in the information display apparatus according to the present invention, the information pattern indicating a position coordinate on display surface 2a is disposed on display apparatus 2, and electronic pen 1 reads the information pattern as an optical image pattern, whereby the position information input by handwriting on display surface 2a by a user can be specified. Specifically, electronic pen 1 performs an operation of emitting detection light to the information pattern disposed on display apparatus 2 to read marks of the information pattern as an optical image pattern. With this operation, a trajectory of electronic pen 1, i.e., a trajectory of handwriting of a character input by handwriting by the user can be detected from the position information read by electronic pen 1.

The information display apparatus transmits the position information read by electronic pen 1 to display apparatus 2. Display apparatus 2 performs an operation of changing the display information displayed on display surface 2a based upon the position information transmitted from electronic pen 1. Accordingly, a user can write a character or graphic on display surface 2a of display apparatus 2 with electronic pen 1 as if he/she writes a character on a sheet by hand with a pen. Electronic pen 1 can also be used as an eraser. In this case, the position of electronic pen 1 is specified by reading the information pattern with electronic pen 1 as in the case of writing a character or graphic, and the display information displayed on display surface 2a is erased based upon the specified position information. Thus, the erasing operation can be realized.

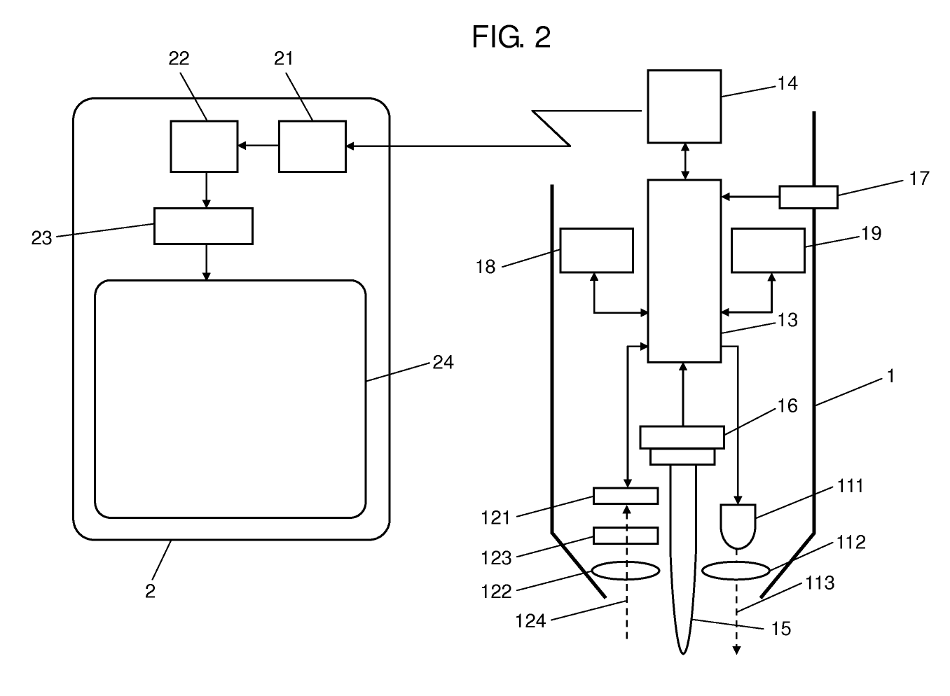

FIG. 2 is a schematic view illustrating a configuration of electronic pen 1 and display apparatus 2 in the information display apparatus according to one exemplary embodiment of the present invention.

As illustrated in FIG. 2, electronic pen 1 includes a light source unit serving as an infrared irradiation unit emitting infrared light to display apparatus 2, and an image reading unit that receives the infrared light reflected from display apparatus 2 and reads the mark of the information pattern as an image of an optical image pattern. The light source unit includes light-emitting diode (hereinafter referred to as LED) 111 that is a light source emitting at least infrared light, and condenser lens 112 that converges the infrared light emitted from LED 111. The image reading unit includes image reading portion 121 having at least an image sensor (CCD) reading the image reflected from display apparatus 2. The image reading unit also includes condenser lens 122 that converges the infrared light reflected from display apparatus 2 to be incident on electronic pen 1, and infrared filter (IR filter) 123 that cuts light with a wavelength of a visible region but passes the infrared light.

Infrared light 113 emitted from LED 111 of electronic pen 1 is converged by condenser lens 112, and emitted to a specified position on display surface 2a of display apparatus 2. On the other hand, infrared light 124 reflected from display apparatus 2 is converged by condenser lens 122, passes through infrared filter (IR filter) 123, and is incident on image reading portion 121.

Specifically, light in a reading region of a predetermined range on display surface 2a of display apparatus 2 is converged on a light-receiving surface of image reading portion 121 by condenser lens 122, and image reading portion 121 of electronic pen 1 reads an image of the mark indicating the position information of the information pattern included in the reading region. The image information read by image reading portion 121 is sent to processing circuit unit 13. Processing circuit unit 13 recognizes the dot-like mark included in the information pattern, and processes the image data of the recognized mark to detect the coordinate of the position indicated by electronic pen 1. Processing circuit unit 13 also converts the read image information into a data signal, and sends the resultant to transmission unit 14. Transmission unit 14 transmits coordinate data to receiving unit 21 of display apparatus 2 by a wireless communication.

Display apparatus 2 processes the data received by receiving unit 21 by processing circuit unit 22, thereby controlling panel drive circuit unit 23. Panel drive circuit unit 23 controls the display operation of display panel 24, whereby the character or graphic is displayed on display surface 2a of display panel 24 based upon the coordinate position recognized by electronic pen 1.

The series of operation described above is executed when a pen tip 15 on a tip end of electronic pen 1 is in contact with display surface 2a. Specifically, electronic pen 1 has pen tip 15 on its tip end, and pressure sensor 16 sensing a pen pressure of pen tip 15 provided therein. When pen tip 15 of electronic pen 1 is brought into contact with display surface 2a of display apparatus 2, this information is transmitted to processing circuit unit 13 from pressure sensor 16. In response to the transmission of this signal, processing circuit unit 13 operates to process the read output of image reading portion 121.

Electronic pen 1 can also change a line thickness or line density according to an output from pressure sensor 16. Specifically, electronic pen 1 can make the line thick or dense with the increase in the output from pressure sensor 16.

It is not limited to the configuration of carrying out the reading operation when the tip end of electronic pen 1 is in contact with display surface 2a. For example, it may be configured such that switch 17 by which the user inputs a reading command is provided, and the reading operation is carried out in response to the depression of switch 17, even if electronic pen 1 is apart from display surface 2a.

Electronic pen 1 has incorporated therein angular sensor 18 for detecting an angle of electronic pen 1, since the coordinate position of the pen tip is different depending upon the tilt of electronic pen 1. For example, when electronic pen 1 is perpendicular, the coordinate of the pen tip is located just below electronic pen 1. When electronic pen 1 greatly tilts, the coordinate of the pen tip is located on a position far from the position just below electronic pen 1. The tilt of electronic pen 1 is measured by angular sensor 18, and tilt data of electronic pen 1 is transmitted to processing circuit unit 13. Processing circuit unit 13 corrects the information of the information pattern acquired by image reading portion 121 based upon the tilt data, thereby being capable of acquiring correct position information without being affected by the tilt of electronic pen 1.

Electronic pen 1 also has incorporated therein an acceleration sensor 19 for detecting a moving speed (including an acceleration) of electronic pen 1. Acceleration sensor 19 detects the moving direction and acceleration data of electronic pen 1, and transmits the detected results to processing circuit unit 13. Processing circuit unit 13 calculates based upon the data of the moving direction and the acceleration data of electronic pen 1 transmitted from acceleration sensor 19, thereby being capable of acquiring a moving amount and the moving direction of electronic pen 1.

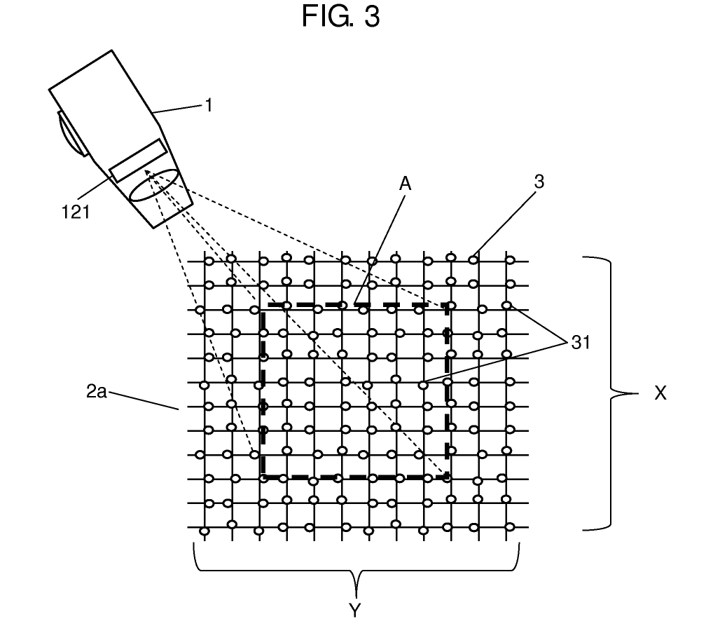

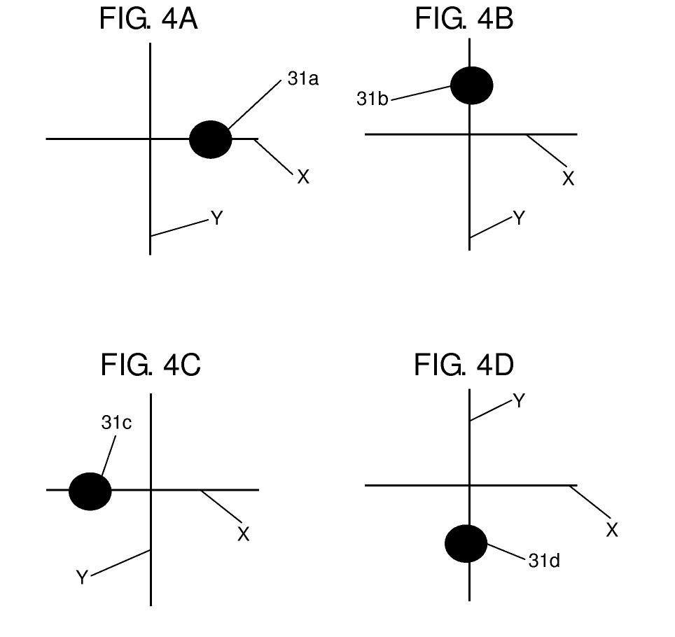

FIGS. 3 and 4A to 4D are explanatory views illustrating one example of the information pattern disposed on display surface 2a of display apparatus 2 and one example of a method of acquiring the position coordinate from the information pattern.

As illustrated in FIG. 3, information pattern 3 having a plurality of marks 31 formed therein with a specific arrangement pattern is disposed on a display region on display surface 2a of display apparatus 2. When a pixel region of m dots×n dots in display surface 2a, e.g., an image region of 6 dots×6 dots, is specified as a unit region A, electronic pen 1 can recognize the position coordinate indicated by electronic pen 1 by reading the mark formed in information pattern 3 in unit region A.

FIGS. 4A to 4D are explanatory views illustrating the arrangement pattern of mark 31 in information pattern 3 and one example of a method of a position coordinate transformation. In this example, as illustrated in FIGS. 4A to 4D, a crossing point formed by grid-like reference lines X and Y is defined as a reference, and mark 31 in information pattern 3 forms marks 31a, 31b, 31c, and 31d that are arrangement patterns disposed on the right side, on the upper side, on the left side, and on the lower side with respect to the crossing point of reference lines X and Y. Numerals “1”, “2”, “3”, and “4” indicating the position coordinate are assigned to the respective marks 31a, 31b, 31c, and 31d. With this, as illustrated in FIG. 3, electronic pen 1 reads mark 31 formed in information pattern 3 in unit region A, whereby the position coordinate in read unit region A can be determined.

Specifically, in information pattern 3, thirty-six marks 31 are disposed in unit region A of 6 dots×6 dots with any one of four arrangements, for example. The information pattern indicating the coordinate position of the specified position can be formed by combining the arrangement patterns according to the specified position in display surface 2a.

Mark 31 in information pattern 3 is made of a material transmitting visible light, and absorbing or reflecting infrared light, whereby the influence to the display image of a visible light region displayed on display surface 2a of display apparatus 2 can be reduced. Mark 31 may be made of a material having a characteristic of a light diffusion or diffraction grating in order to change the direction of incident infrared light emitted to mark 31. In this case, mark 31 has light diffusion property or diffraction performance. Therefore, light incident on mark 31 is reflected (scattered, diffused, diffracted, phase-changed, flexed) by mark 31, and outputted again to the outside of display apparatus 2, whereby mark 31 can be detected by the reflected light.

Subsequently, one example of a configuration of the display panel of display apparatus 2 in the information display apparatus will be described.

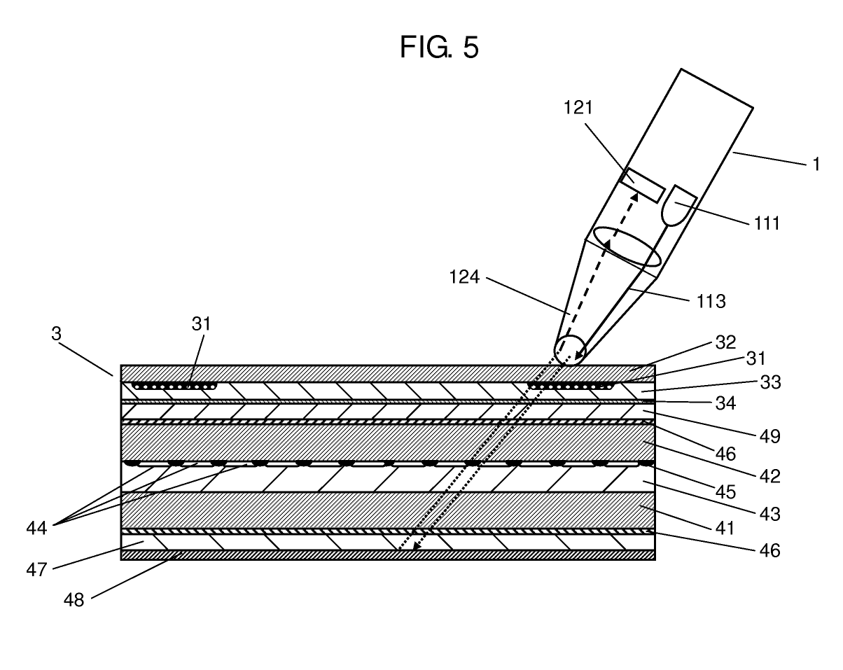

FIG. 5 is a schematic view illustrating a configuration of the display panel on which the information pattern is disposed in display apparatus 2. The display panel in FIG. 5 is an active matrix TFT color liquid crystal display panel.

In FIG. 5, a liquid crystal display panel unit is configured by sealing liquid crystal material 43 between translucent substrates 41 and 42 that are two opposing glass substrates. Although not illustrated, a thin-film transistor serving as a driving element of liquid crystal, a single transparent electrode, a signal electrode, and a scanning electrode are formed on lower substrate 41 of the liquid crystal display panel unit. Color filter 44 made of at least red (R), green (G), and blue (B), black matrix 45 having an opening through which the respective colors pass, and serving as a light shielding member made of a metal thin film such as chrome blocking out light on the boundary of the respective colors, and other transparent electrode are formed on the surface of upper substrate 42 opposite to substrate 41. Liquid crystal material 43 is disposed between transparent electrodes formed on two substrates 41 and 42. Polarizing plate 46 is adhered on the outer surface of each of substrates 41 and 42.

Color filter 44 is not limited to RGB. Color filter 44 may form pixels of cyan (C), magenta (M), and yellow (Y). Color filter 44 may form a pixel of white (W).

Surface light source member 47 and diffuse reflection sheet 48, which form a backlight apparatus, are disposed on the backside of the liquid crystal display panel unit, i.e., on polarizing plate 46 on lower substrate 41. On-Cell capacitance touch panel 49 is disposed on the display surface of the liquid crystal display panel unit, i.e., on polarizing plate 46 on upper substrate 42. Touch panel 49 may be an In-Cell touch panel, or a resistive pressure-sensitive touch panel. Touch panel 49 may not be provided.

The liquid crystal display panel unit is configured to include a plurality of pixels, including sub-pixels of a plurality of light-emitting colors, in a matrix. A thin-film transistor of the sub-pixel forming each pixel is controlled to be turned on or off, and polarized nature of liquid crystal material 43 is selectively controlled, whereby a character or graphic can be displayed with color.

Information pattern 3 having a plurality of marks 31 for reading the position information by electronic pen 1 is disposed on touch panel 49 of the liquid crystal display panel unit. As illustrated in FIG. 5, information pattern 3 is formed such that the plurality of circular or rectangular marks 31 are formed on resin translucent base film 32 with a predetermined arrangement, and translucent resin layer 33 for adjusting refractivity is formed on base film 32 so as to cover marks 31. Adhesive layer 34 made of a translucent adhesive material is formed on resin layer 33. Information pattern 3 is adhered on touch panel 49 of the liquid crystal display panel unit by adhesive layer 34 with base film 32 being located close to the display surface.

Mark 31 in information pattern 3 is made of a material transmitting visible light, and absorbing infrared light, whereby the influence to the color display image of a visible light region displayed on the liquid crystal display panel unit can be reduced.

As illustrated in FIG. 5, infrared light 113 emitted from electronic pen 1 is firstly emitted to information pattern 3. In information pattern 3, infrared light 113 is absorbed on the position where marks 31 are disposed, while on the position where marks 31 are not disposed, infrared light 113 passes through the liquid crystal display panel unit, is reflected on diffuse reflection sheet 48, and enters electronic pen 1. Specifically, electronic pen 1 reads incident infrared light 124 by image reading portion 121, thereby being capable of detecting the coordinate information by marks 31 formed in information pattern 3.

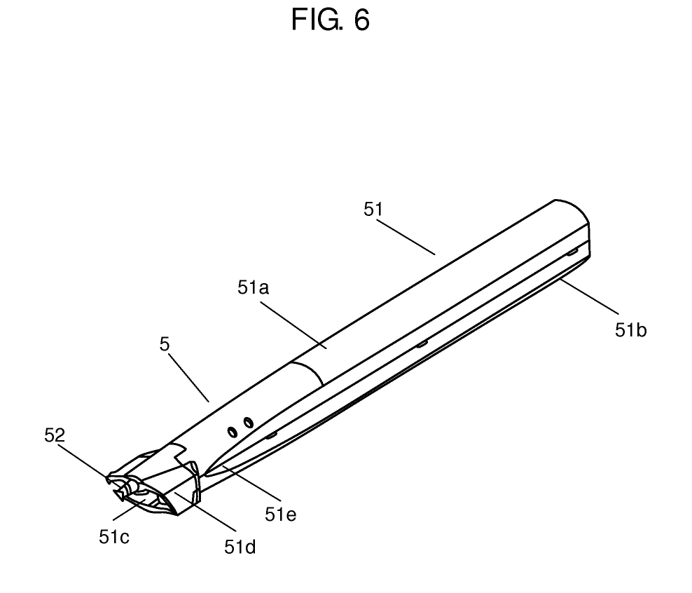

Subsequently, an electronic pen serving as the information reading device according to one exemplary embodiment of the present invention will be described with reference to FIGS. 6 to 11.

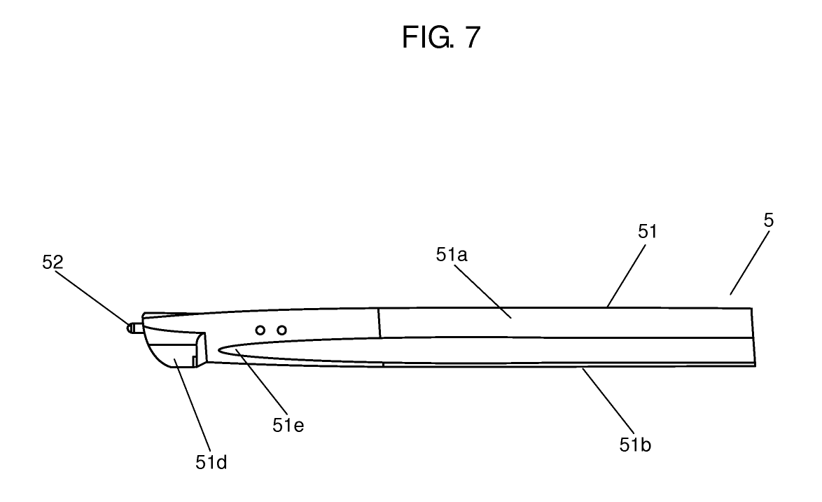

FIG. 6 is a perspective view illustrating an appearance of the electronic pen according to one exemplary embodiment of the present invention. FIG. 7 is a plan view of the appearance of the electronic pen viewed from a lateral direction according to one exemplary embodiment of the present invention.

As illustrated in FIGS. 6 and 7, electronic pen 5 includes the light source unit emitting infrared light to information pattern 3, and the image reading unit reading information from information pattern 3, those of which are stored in cylindrical plastic case 51 having upper case 51a and lower case 51b. A battery and the like are stored in case 51 in addition to the light source unit and the image reading unit. Opening 51c from which infrared light is emitted and to which infrared light reflected from the display apparatus is incident is formed on the leading end of case 51. Pen tip 52 is disposed to project from opening 51c to the tip end. An internal structure will be described in detail later.

Case 51 is provided with projecting portion 51d formed on its leading end to have a diameter larger than the other part of case 51, and grip portion 51e formed rearward of the projecting portion 51d to have a diameter smaller than the other part of case 51.

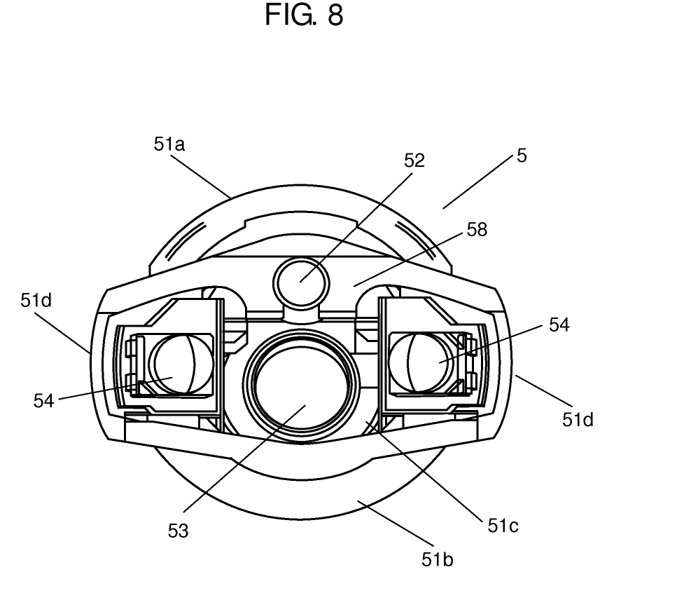

FIG. 8 is a plan view of the appearance of the electronic pen viewed from the opening of the electronic pen on its tip end according to one exemplary embodiment of the present invention. As illustrated in FIG. 8, in electronic pen 5, image reading unit 53 that receives infrared light reflected from display apparatus 2 for reading an image is disposed on almost a center of opening 51c on the leading end of case 51. Two light source units 54, each having an LED serving as a light source for emitting infrared light and a condenser lens, are disposed on both sides of opening 51c of case 51 across image reading unit 53. Two light source units 54 are disposed in projecting portion 51d formed on the leading end of case 51. Specifically, two light source units 54 disposed on the leading end emit infrared light to display apparatus 2 having information pattern 3 that is a subject to be read, and image reading unit 53 disposed on almost the center reads the reflected infrared light.

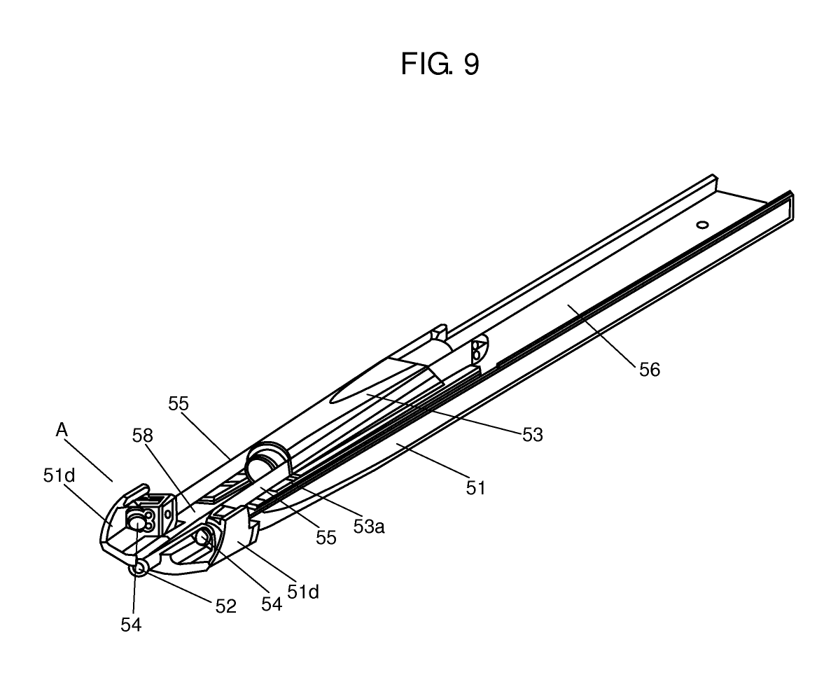

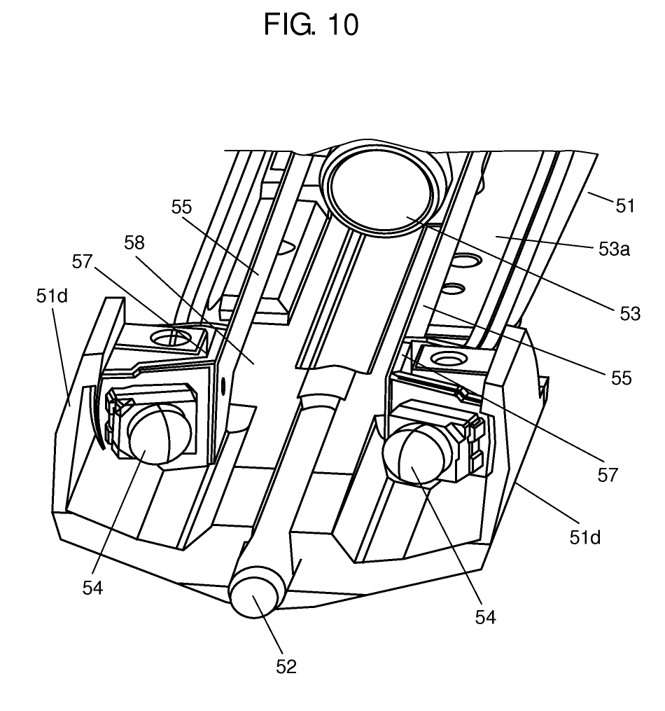

FIG. 9 is a perspective view illustrating an internal structure of the electronic pen with the lower case being removed according to one exemplary embodiment of the present invention. FIG. 10 is an enlarged perspective view illustrating an A part in FIG. 9.

As illustrated in FIGS. 9 and 10, each of two light source units 54 includes the LED serving as a light source for emitting infrared light, and flexible wiring board 55 on which the LED is mounted. Flexible wiring board 55 is electrically connected to control circuit board 56 incorporated in case 51 on its rear side. Each of light source units 54 is provided with a thermal conductive portion disposed on the back surface opposite to the surface of flexible wiring board 55 on which the LED of light source unit 54 is mounted. The thermal conductive portion includes L-shaped metal plate 57 mounted via a thermal conductive adhesive member, whereby heat generated from the LED of light source unit 54 is radiated to metal plate 57. With this structure, heat generated by the LED can effectively be radiated to the thermal conductive portion, whereby the lifetime of the LED can be prolonged.

As illustrated in FIG. 10, L-shaped metal plate 57 to which the LED of light source unit 54 is mounted is disposed such that one surface is disposed on the back surface opposite to the surface of the flexible wiring board on which the LED is mounted, and the other surface is bent to extend toward the inside of case 51 so as to be apart from projecting portion 51d of case 51. With this structure, heat generated on the LED of light source unit 54 can be released to the inside of case 51 from projecting portion 51d through metal plate 57 on the thermal conductive portion. Therefore, this structure can allow a user to hardly sense heat from light source unit 54, when he/she grips electronic pen 5.

Metal plate 57 may have a shape other than the L-shape. For example, metal plate 57 may be a flat plate. One surface on the leading end of metal plate 57 may be mounted on the back surface opposite to the surface of flexible wiring board 55 on which the LED of light source unit 54 is mounted, and the other surface on the trailing end may extend toward the inside of case 51 so as to be apart from projecting portion 51d of case 51. The thermal conductive portion may be provided by forming a metal pattern such as copper on the back surface opposite to the surface of flexible wiring board 55 on which the LED is mounted. In this case, flexible wiring board 55 is disposed such that a part of the thermal conductive portion extends toward the inside of case 51 so as to be apart from projecting portion 51d of case 51.

Two light source units 54 are disposed such that metal plate 57 is mounted to support member 58 supporting pen tip 52. According to this structure, the light source unit is configured, and stored in the leading end of case 51.

Mounting portion 53a of image reading unit 53 is mounted on the rear of support member 58 with a screw (not illustrated), and a wiring portion extracted from image reading unit 53 is electrically connected to control circuit board 56.

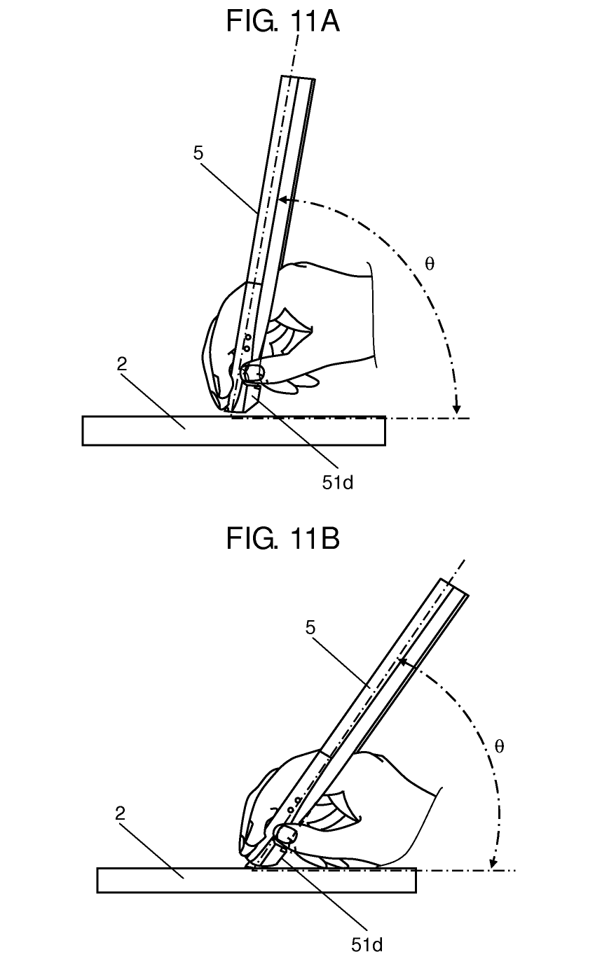

FIGS. 11A and 11B are explanatory views illustrating a state in which a user uses the electronic pen according to one exemplary embodiment of the present invention. FIG. 11A illustrates the state in which the user uses the electronic pen almost vertically, while FIG. 11B illustrates the state in which the user tilts the electronic pen when he/she uses the electronic pen.

As illustrated in FIGS. 11A and 11B, when the user uses electronic pen, the tilt of electronic pen 1 to display surface 2a of display apparatus 2, i.e., to information pattern 3, can be restricted to be tilt angle θ, e.g., tilt angle θ of not less than 45°, by which correct information can be read from information pattern 3, since projecting portion 51d is formed on the leading end of case 51.

As described above, in the electronic pen according to the present invention, case 51 has the projecting portion 51d formed on its leading end to have a diameter larger than the other part, and light source unit 54 is disposed in projecting portion 51d. This structure can allow light source unit 54 to be disposed with a compact design. Since projecting portion 51d is present on the leading end, the user can use electronic pen with an appropriate pen pressure.

Case 51 is provided with projecting portion 51d formed on its leading end to have a diameter larger than the other part, and grip portion 51e formed rearward of the projecting portion 51d to have a diameter smaller than the other part. The user can grips the grip portion 51e, which is formed to have a diameter smaller than the other part, with his/her thumb and long finger or annular finger, when using electronic pen 5. Since projecting portion 51d is present in the direction of pen tip 52 in which a pen pressure is applied, the easy-to-use electronic pen can be provided.

Projecting portion 51d restricting the tilt of the electronic pen, which is currently used, to be the tilt angle, by which the information can be read from the information pattern, is provided on the leading end of case 51. According to this structure, correct information pattern can be read, even if the user uses the electronic pen without worrying about the tilt of the electronic pen during the use by the user.

In the present embodiment, infrared light is used as light for detecting the coordinate information formed on information pattern 3. However, the present invention is not limited to the configuration using infrared light. For example, when mark 31 of information pattern 3 is made of a material absorbing or reflecting light with a wavelength of visible light region, such as blue, green, and red, light with a wavelength of visible light region can be used as light for detecting the coordinate information formed on information pattern 3, other than infrared light.

What is claimed is:

1. An information reading device comprising:
a light source unit that emits light to an information pattern having a plurality of marks that can optically be read;
an image reading unit that reads information from the information pattern; and
a case that houses the light source unit and the image reading unit and has on a leading end an opening through which the light from the light source unit is emitted to the information pattern and into which light for reading information by the image reading unit enters, wherein
the case has a projecting portion formed on the leading end, the projecting portion having a diameter larger than other parts of the case.

2. The information reading device according to claim 1, wherein the case has a grip portion formed rearward of the projecting portion, the grip portion having a diameter smaller than other parts of the case.

3. The information reading device according to claim 1, wherein the light source unit is disposed in the projecting portion of the case.

4. The information reading device according to claim 1, wherein the projecting portion on the leading end of the case restricts a tilt of the information reading device, when the device is used, to a tilt angle which allows reading information from the information pattern.

5. The information reading device according to claim 1, wherein the information pattern is disposed on a display apparatus and indicates position information of a display surface of the display apparatus.

6. The information reading device according to claim 1, wherein the image reading unit is disposed on a center of the opening on the leading end of the case, and the light source unit is disposed on both sides of the image reading unit and in the projecting portion of the case.
